(19) United States
(12) Patent Application Publication
(10) Pub. No.: US 2013/0081112 A1
(43) Pub. Date: Mar. 28, 2013

(54) Global Terminal Management Using 2-Factor Authentication

(71) Applicant: Tadhg Kelly, Boonton, NJ (US)

(72) Inventor: Tadhg Kelly, Boonton, NJ (US)

(21) Appl. No.: 13/625,008

(22) Filed: Sep. 24, 2012

Related U.S. Application Data
(60) Provisional application No. 61/539,154, filed on Sep. 26, 2011.

(51) Int. Cl. G06F 21/20

(52) U.S. Cl. 726/4

(57) ABSTRACT

A terminal management system for an enterprise network, having a terminal management server functionally connected to an enterprise network. The terminal management system includes at least one network device and a secure shell client that are also functionally connected to the enterprise network. The secure shell client establishes a temporary direct connection to the network device after being validated as having an approved secure connection module. This validation is accomplished by software modules running on the terminal management server. This temporary connection may be converted to a maintained direct connection if the software modules on the terminal management server determine that the secure shell client connected to the network device is the same one validated as having an approved secure connection module.

### CLAIM OF PRIORITY

This application claims priority to U.S. Provisional Patent Application 61/539,154 filed on 26 Sep. 2011 by Kelly entitled “Global Terminal Management using 2-factor authentication.

### FIELD OF THE INVENTION

The invention relates to a system for managing a network of interconnected devices, and more particularly, to managing a large scale, geographically distributed enterprise network by a global terminal management system using 2-factor authentication.

### BACKGROUND OF THE INVENTION

Most modern enterprises rely on complex, enterprise-wide, computer networks to facilitate and coordinate work and communication between staff members. These enterprise networks are often spread over significant geographic areas, and may even span several continents. Managing the devices attached to the network is typically done remotely, by a network manager using the network itself to access and update the various devices.

A concern with managing devices in this manner is of maintaining security. To keep the system current and efficient, there is a desire to allow technicians quick access to any device on the network that requires modification. Such access can, however, provide huge security holes in the enterprise network, potentially allowing competitors and other malicious operators to obtain access to confidential information, and/or the ability to compromise or even disable key system devices.

The present invention allows quick and easy—but secure, authorized, monitored and logged—access by any authentic network technical support.

### DESCRIPTION OF THE RELATED ART

The relevant prior art involving out-of-band network management includes:

U.S. Pat. No. 7,640,581 granted to Brenton, et al. on Dec. 29, 2009 entitled “Method and system for providing secure, centralized access to remote elements” that describes a system and method for establishing centralized, out-of-band access to remote network elements is provided. Status and other information can be securely retrieved from the remote elements. One or more servers observe and manage a plurality of remote elements using modem-to-modem communications between a modem bank and a remote modem. Requests are submitted through a central mediation point, thereby allowing central control of user profiles and a collection of security audit log information. One or more authentication mechanisms provide enforced security measures and trusted communication paths between a user and a remote element. Remote elements can be securely monitored and administered from a central location.

U.S. Pat. No. 6,678,826 granted to Kelly, et al. on Jan. 13, 2004 entitled “Management system for distributed out-of-band security databases” that describes a management system is disclosed for distributing security databases to security gates at each maintenance port of each network element. A distributed database manager is provided to instantaneously update the databases and gather from each database transaction records. Central to the distributed database manager is a software program that polls the security databases located at each of the network elements, deposits updated databases, and formats various management reports from transaction records and from device failure records (generated by the program). The software program enables the database manager to communicate with the network elements through either an in-band channel or an out-of-band channel. By shifting authentication of access seekers to security databases resident at each console port, security is maintained even though the network server is not in service. Using existing technology, all communications between the distributed database manager and the security database is in encrypted form.

U.S. Pat. No. 7,171,467 granted to Carley on Jan. 30, 2007 entitled “Out-of-band remote management station” that describes a computer network management system with an embedded processor, an analog communication means and a digital interface for network management provides a system for remotely and securely managing a network. Backup power in the form of an uninterrupted power supply, or other power means as appropriate, allows the modem to provide power outage notification to a remote site. The system further provides authentication and authorization capabilities for security purposes.

U.S. Pat. No. 7,895,462 granted to Erickson, et al. on Feb. 22, 2011 entitled

“Managing recovery and control of a communications link via out-of-band signaling” that describes a computer program product, apparatus and method for managing recovery and control of a communications link via out-of-band signaling. An exemplary embodiment includes sending a command, sending an invalidate request to a buffer associated with the command and receiving a response to the invalidate request at least one of prior to the command reaching the recipient and after the command reaching the recipient.

Various implements are known in the art, but fail to address all of the problems solved by the invention described herein. One embodiment of this invention is illustrated in the accompanying drawings and will be described in more detail herein below.

### SUMMARY OF THE INVENTION

The present invention relates to a terminal management system for an enterprise network.

In a preferred embodiment, the terminal management system may include a terminal management server capable of being functionally connected to an enterprise network. The terminal management system may also include at least one network device capable of being functionally connected to the enterprise network and having an out-of-band secure shell module that may also be functionally connected to the terminal management server.

In a preferred embodiment, the secure shell client may establish a temporary direct connection to the network device after the network device invokes a connection to the terminal management server and the secure shell client has been validated as having an approved secure connection module. This validation may be accomplished by a suite of software modules running on the terminal management server.

This temporary direct connection between the secure shell client and the out-of-band secure shell module may only be converted to a maintained direct connection if a suite of software modules running on the terminal management server determines that the secure shell client connected to the network device is the same secure shell client validated as having an approved secure connection module.

Therefore, the present invention succeeds in conferring the following, and others not mentioned, desirable and useful benefits and objectives.

It is an object of the present invention to provide a secure out-of band management system in which the accessed device's private key never leaves the server so it is less likely to be compromised.

It is another object of the present invention to provide a secure out-of-band management system which eliminates rogue copies of an SSH client being used on an enterprise network.

Yet another object of the present invention is to provide a secure out-of-band management system in which so all command line interface (CLI) sessions are audited and recorded for forensics and there is no way to bypass this process for covert operations.

Still another object of the present invention is to encrypt all logging and audit files to prevent alteration.

Still another object of the present invention is to force all secure shell protocol (SSH) connections through the out-of-band manger (OBM) database, therefore providing complete audit of all connections and full keystroke logging.

### BRIEF DESCRIPTION OF THE DRAWINGS

FIG. 1 shows a schematic overview of a preferred embodiment of the present invention.

FIG. 2 shows a flow chart of representative steps in performing the method of the present invention.

FIG. 3 shows a schematic overview of a first factor authentication of a preferred embodiment of the present invention.

FIG. 4 shows a schematic overview of a second factor authentication of a preferred embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

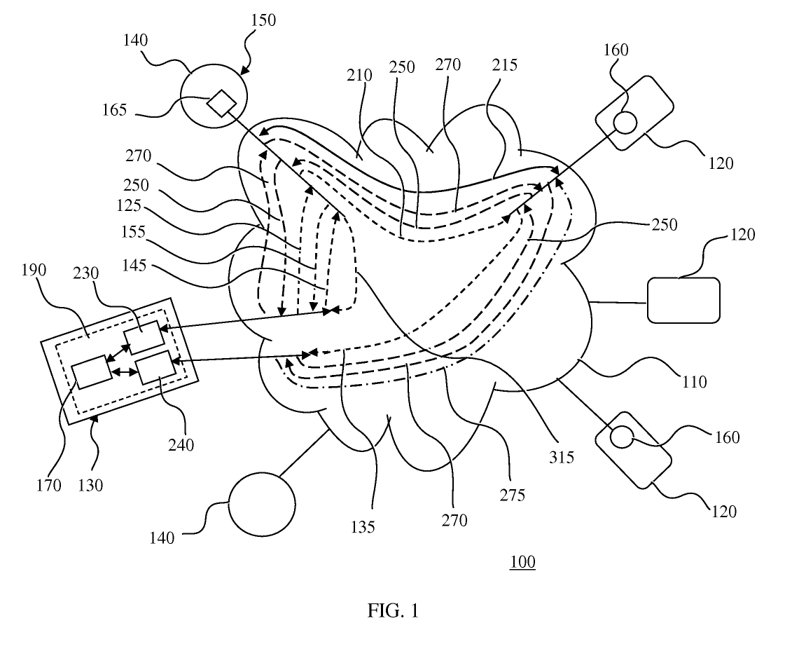

FIG. 1 shows a schematic overview of a preferred embodiment of the present invention.

In a preferred embodiment, a terminal management system 100 is designed for an enterprise network 110. The terminal management system 100 may include a terminal management server 130 that may be functionally connected to the enterprise network 110. The enterprise network 110 may also include at least one network device 120 that may also be functionally connected to the enterprise network 110. The network device 120 preferably also has an out-of-band secure shell module 160 functionally connected to the terminal management server 130.

In a preferred embodiment, a secure shell client 140 may establish a temporary direct connection 210 to the network device 120. This connection may be made by the secure shell client 140 initially connecting to the terminal management server 130. The terminal management server 130 may then establish that the secure shell client 140 has an approved secure connection module 165. This verification may, for instance, be accomplished by a suite of software modules 190 running on the terminal management server 130. Once the terminal management server 130 has verified that the secure shell client 140 does have an appropriate approved secure connection module 165, the user of the secure shell client 140 may be presented with a list of network devices 120 to which they may connect.

The secure shell client 140 may then establish a temporary direct connection 210 to a selected network device 120. The network device 120 may then invoke a connection 135 to the terminal management server 130. The terminal management server 130 may then be able to determine if the secure shell client 140 that has connected to the network device 120 is the same one that was verified as having an approved secure connection module 165.

This verification may, for instance, be accomplished by a suite of software modules 190 running on the terminal management server 130. It may, for instance, take the form of the application server 230 sending an addressed message 145 to the secure shell client 140. The secure shell client 140 may then return this message back to the application server 230 in the form of a confirmation message 155. Once the verification is accomplished, the application server 230 may send the secure shell client 140 a connection authorization message 125, allowing the temporary direct connection 210 to be converted into a maintained direct connection 215.

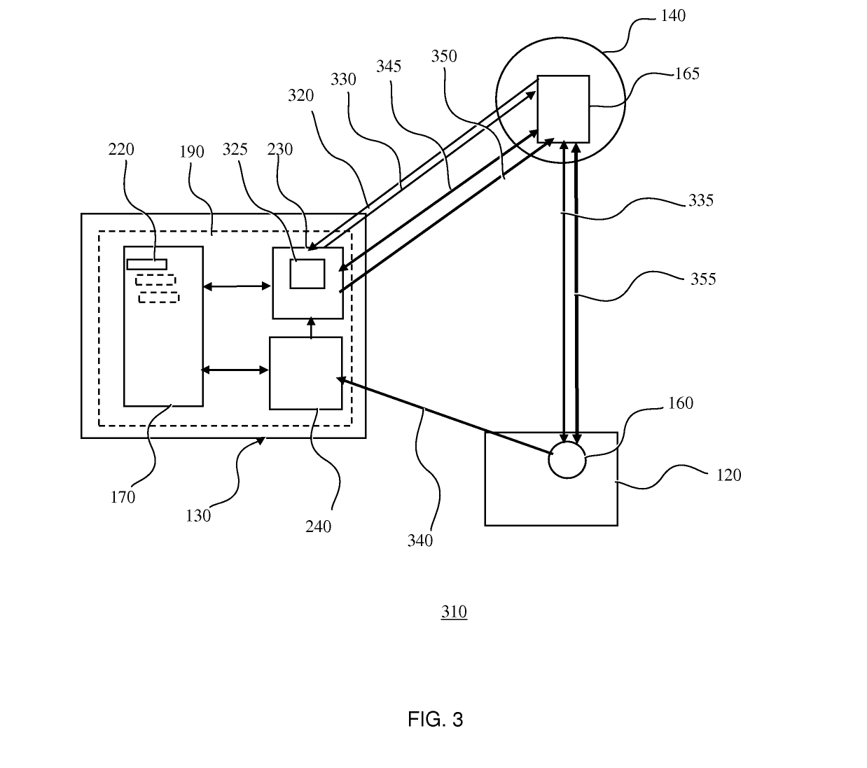

As shown in FIG. 1, the software module, or Global Terminal Manager, 190 running on the terminal management server 130 may include a number of modules, such as, but not limited to, an application server 230, an authentication server 240 and a terminal manager database 170. The suite of software modules 190 may, for instance, be programmed to securely perform discovery of secure shell enabled network devices 120 that are functionally connected to the enterprise network 110, and to securely store information regarding the discovered network devices 120 on the terminal manager database 170. This stored information may include data such as, but not limited to, private encryption keys 220 (shown in FIG. 3) for the discovered network devices 120.

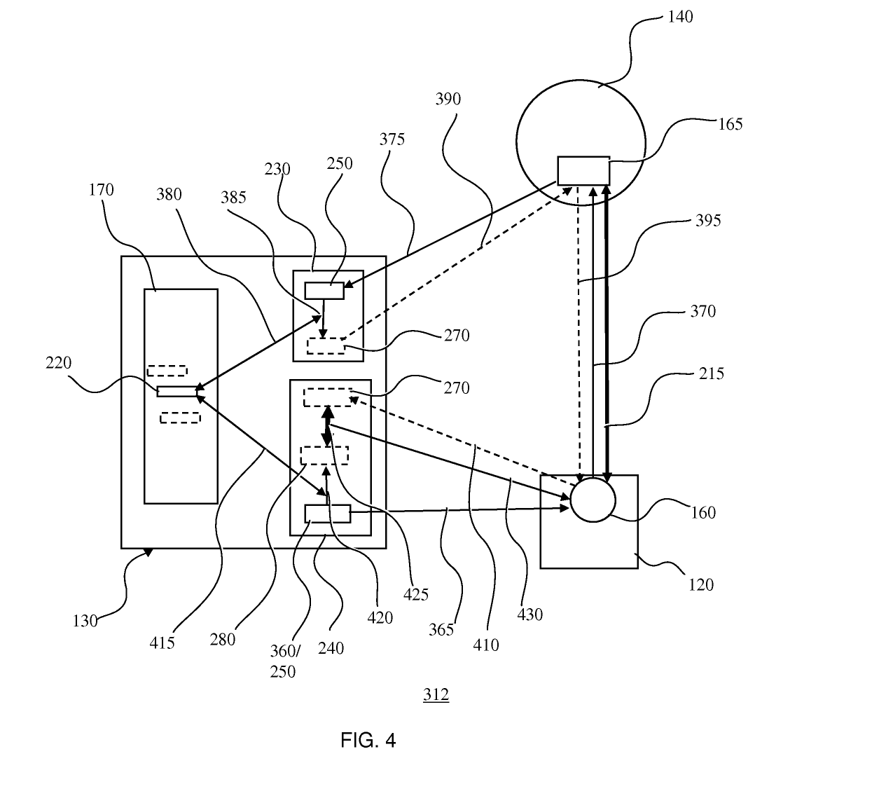

This suite of software modules 190 may, for instance, be used to further determine and ensure that the secure shell client 140 connected to the network device 120 is the same client validated as being one of a particular type of secure shell client 150 that has an approved secure connection module 165. This further verification may, for instance, be accomplished using a challenge-response verification 260 (shown in FIG. 4) routed so that all encryption involved in the verification 260 occurs within the terminal management server 130.

In a preferred embodiment, the challenge-response verification 260 may comprise actions such as, but not limited to, the following:

The authentication server 240 may initiate the further verification by automatically generating a substantially random challenge 250 and sending that random challenge 250 to the network device 120. The random challenge 250 may, for instance, be a stream of alpha/numeric characters such as, but not limited to, a random eight bit alpha/numeric challenge.

The network device 120 may then send the random challenge 250 onto the secure shell client 140 that has established a temporary direct connection 210 with it.

The secure shell client 140 may then send the random challenge 250 on to the application server 230 that it originally sent a request to establish a direct connection 315 with a network device 120.

The application server 230 may then obtain the private encryption key 220 of the network device 120 from the terminal manager database 170 and encrypt the random challenge 250 using that private encryption key 220. The result will be an encrypted response 270 that may be transmitted back to the secure shell client 140. The secure shell client 140 may in turn transmit the encrypted response 270 onto the network device 120. The selected network device 120 may then transmit the encrypted response 270 to said authentication server 240.

The authentication server 240 may then obtain the private encryption key 220 of the selected network device 120 from the terminal manager database 170 and encrypt the random challenge 250 using those private encryption keys 220. In this way, the authentication server 240 may produce a replica of the encrypted response 280 (shown in FIG. 3) provided by the application server 230 and that has been relayed via the secure shell client 140 and the network device 120. The authentication server 240 may then compare the replica and its own version of the encrypted response 270.

If they match, the authentication server 240 may then be satisfied that the secure shell client 140 connected to the network device 120 is the same one it verified as having an approved secure connection module 165 and may send a connection authorization message 275 to the network device 120 instructing it to convert the temporary direct connection 210 to a substantially permanent direct connection 215.

If the response and the replica response do not match to within a predetermined level, the authentication server 240 may instruct the network device 120 to terminate the direct connection 210 with the secure shell client 140.

In a preferred embodiment, the terminal management system may record a log of keystrokes 290 of the workstation on which the secure shell client 140 is running. This record, or log, of keystrokes 290 (shown in FIG. 3) on the secure shell client 140 may be stored in an encrypted form on the terminal manager database 170.

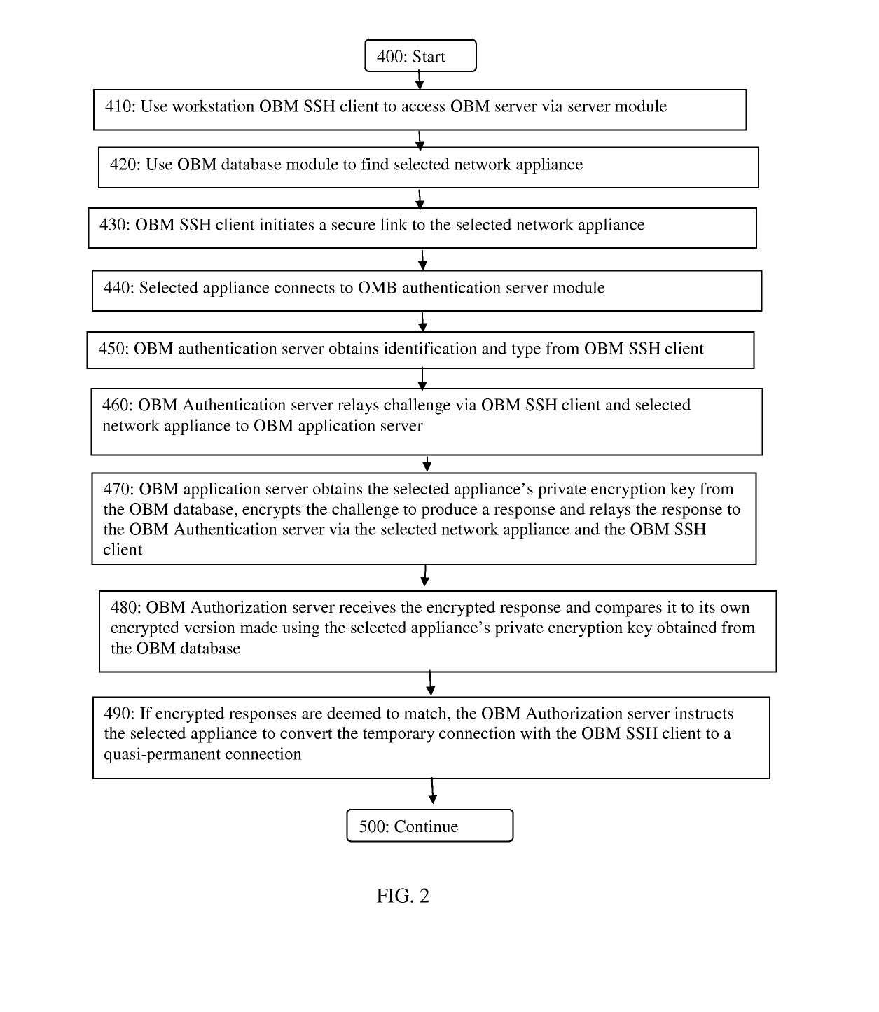

FIG. 2 shows a flow chart of representative steps in performing the method of the present invention.

In step, 400: “Start”, the process may be initialized.

In step 410: “Use workstation OBM SSH client to access OBM server via server module”, a user on a workstation may contact a terminal management server 130 in order to be able to access a network device 120.

In step 420: “Use OBM database module to find selected network appliance”, the application server 230 may obtain a list of relevant network devices 120 that the user on the secure shell client 140 may access. The user may then select a specific network device 120 that they want to contact.

In step 430: “OBM SSH client initiates a secure link to the selected network appliance”, the user may establish a direct link from the secure shell client 140 to the selected network device 120.

In step 440: “Selected appliance connects to OMB authentication server module”, the network device 120, having been contacted by the secure shell client 140 may then initiate a link to the terminal management server 130.

In step 450: “OBM authentication server obtains identification and type from OBM SSH client”, the terminal management server 130, having been contacted by the network device 120, may then interrogate the secure shell client 140 to establish that the secure shell client 140 has the appropriate approved secure connection module 165. In an alternate embodiment, this authentication step may be taken after step 430, when the secure shell client 140 first contacts the terminal management server 130.

In step 460: “OBM Authentication server relays challenge via OBM SSH client and selected network appliance to OBM application server”, the authentication server 240 may generate a random, or pseudo random, alpha-numeric sequence. This sequence may then be relayed around the enterprise network 110 via the selected network device 120 and the secure shell client 140 to the application server 230.

In step 470: The OBM application server obtains the selected appliance's private encryption key from the OBM database, encrypts the challenge to produce a response and relays the response to the OBM Authentication server via the selected network appliance and the OBM SSH client.

In step 480: The OBM Authorization server receives the encrypted response and compares it to its own encrypted version made using the selected appliance's private encryption key obtained from the OBM database.

In step 490: If encrypted responses are deemed to match, the OBM Authorization server instructs the selected appliance to convert the temporary connection with the OBM SSH client to a quasi-permanent connection.

In a preferred embodiment, the application server 230, the authentication server 240 and the terminal manager database 170 all reside on the same terminal management server 130. In this way, although the challenge and response are relayed by the devices that are in contact, the encryption and decryption are all done on the same terminal management server 130. No keys or codes need, therefore, to be sent over the network, yet the authentication server 240 can be confident that the correct, authorized secure shell client 140 is communicating with the selected network device 120.

FIG. 3 shows a schematic overview of a first factor authentication 310 of a preferred embodiment of the present invention.

The secure connection module 165 operative on the secure shell client 140 may initiate a connect 320 with the application server 230 operative on the terminal management server 130.

The application server may then validate 325 the secure connection module as an approved secure connection module, i.e., that may conform to standards required by the terminal management server 130 such as, but not limited to, being correctly configured, running approved communication software, operating with approved communications protocol and implementing appropriate audit trails and backup or some combination thereof.

The secure connection module may then receive a permission 330 to connect to at least one network device. The permission to connect may, for instance, include information such as, but not limited to, a list of the network devices 120 that the approved secure connection module 165 may connect to. The permission to connect may also supply additional information about one or more of the network device 120 such as, but not limited to, connection parameters, addresses, accepted communication and security protocols, or some combination thereof.

The approved secure connection module 165 may then establish a preliminary direct connection 335 to an out-of-band secure shell module 160 operative on a network device 120.

The out-of-band secure shell module may then report 340 to the authentication server 240 operative on the terminal management server 130. This report of the establishment of a preliminary direct connection between the out-of-band secure shell module 160 and the approved secure connection module 165 may include identification parameters concerning the approved secure connection module 165 such as, but not limited to, contact address of the approved secure connection module 165 as presented to the out-of-band secure shell module 160, protocols being used, time of establishment of the connection, volumes of traffic flow over the connection or some combination thereof.

The authentication server 240 may then pass all, or relevant parts, of this information on to the application server 230.

The application server may then confirm 345 that the secure connection module connected to the out-of-band secure shell module is the validated, approved secure connection module that contacted the application server 230 to initiate the contact. This confirmation may include an authentication procedure such as, but not limited to, a challenge/response authentication. A challenge-response authentication may be an authentication process that verifies an identity by requiring correct authentication information to be provided in response to a challenge. The authentication information may be a value that is computed in response to an unpredictable challenge value, but may be just a password.

Having made an initial confirmation that the approved secure connection module 165 may be the one approved earlier, the application server may issue a permission 350 to convert, or upgrade, the preliminary direct connection to being a temporary direct connection 355.

FIG. 4 shows a schematic overview of a second factor authentication 312 of a preferred embodiment of the present invention.

Having permitted the establishment of a temporary direct connection 355 between the approved secure connection module 165 and the out-of-band secure shell module 160, the terminal management server 130 may then take further steps to provide further assurance that the approved secure connection module 165 is the device it purports to be.

This second factor authentication 312 may take the form diagramed schematically in FIG. 4. The authentication server 240 may initiate the procedure by creating 360 a substantially random challenge 250. The substantially random challenge 250 may, for instance, be sequence, or string, of characters such as, but not limited to, an alpha-numeric string having a present number of characters such as being a string of 10 or more characters, or a string of at least 15 characters or more. The longer the string, the less likely it is to be guessed or otherwise compromised.

The authentication server 240 may send 365 the substantially random challenge 250 to the out-of-band secure shell module 160. The out-of-band secure shell module 160 may, in turn, relay 370 the random challenge to the approved secure connection module 165. The approved secure connection module may then relay 375 the random challenge on to the application server 230.

Having received the substantially random challenge 250, the application server may fetch 380 the private encryption key 220 of the network device 120, and it's associated out-of-band secure shell module 160 from the terminal manager database 170.

The application server may then encrypt 385 the substantially random challenge 250 using the private encryption key 220 to produce an encrypted response 270.

The application server may then send 390 the encrypted response 270 to the approved secure connection module 165. The approved secure connection module may, in turn, relay 395 the encrypted response 270 on to the out-of-band secure shell module 160. The out-of-band secure shell module 160 may then relay 410 the encrypted response 270 on to the authentication server 240.

Meanwhile, the authentication server 240 may fetch 415 the private encryption key 220 of the out-of-band secure shell module 160 from the terminal manager database 170. The authentication server 240 may then encrypt 420 the substantially random challenge 250 using the private encryption key 220 to produce a replica 280 of the encrypted response.

The authentication server 240 may then compare 425 the replica of the encrypted response 280 to the encrypted response received from the application server 230 by way of the approved secure connection module 165 and the out-of-band secure shell module 160.

If a match is established between the replica of the encrypted response 280 and the encrypted response 270, to within a predetermined degree of precision, the authentication server 240 may then send a connection authorization message 430 to the out-of-band secure shell module 160.

The connection authorization message may, for instance, allow the approved secure connection module to upgrade, or change, the preliminary direct connection 335 between the approved secure connection module and the out-of-band secure shell module into a maintained direct connection 215.

The difference between the preliminary direct connection 335 and the maintained direct connection 215 may, for instance, relate to usage parameters such as, but not limited to, upgrading the amount of time the connection will be allowed to persist, the amount of idle time since the last use of the connection that may be allowed, the quantity of traffic allowed, the bandwidth of the connection, the types of protocol allowed in a connection or some combination thereof. In general, the maintained direct connection 215 may allow easier and quicker message flow between the approved secure connection module 165 and the out-of-band secure shell module 160 and hence between the secure shell client 140 and the network device 120.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A terminal management system for an enterprise network, comprising:
a terminal management server functionally connected to said enterprise network;
at least one network device functionally connected to said enterprise network, said network device comprising an out-of-band secure shell module functionally connected to said terminal management server;
a secure shell client having a secure connection module; and
a maintained direct connection between said secure shell client and said network device, said maintained direct connection being established by steps comprising:
connecting by said secure shell client, said secure shell client to said terminal management server;
validating, by an application server operative on said terminal management server, said secure connection module as an approved secure connection module;
receiving by said secure connection module from said application server module, a permission to connect to at least one network device;
establishing, by said approved secure connection module, a preliminary direct connection between said approved secure connection module and said out-of-band secure shell module;
reporting, by said out-of-band secure shell module to an authentication server operative on said terminal management server, said establishment of said preliminary direct connection;
confirming, by said application server, via a challenge response communication with said secure connection module that said secure connection module connected to said out-of-band secure shell module is said validated, approved secure connection module;
issuing by said application server to said approved secure connection module if said confirmation occurs, permission to convert said preliminary direct connection to a temporary direct connection;
creating, by said authentication server, a substantially random challenge;
sending, by said authentication server to said out-of-band secure shell module, said substantially random challenge;
relaying, by said out-of-band secure shell module to said approved secure connection module, said substantially random challenge;
relaying, by said approved secure connection module to said application server, said substantially random challenge;
fetching, from said terminal manager database by said application server, a private encryption key of said network device;
using, by said application server, said private encryption keys to encrypt said substantially random challenge to produce an encrypted response;
sending, by said application server to said approved secure connection module, said encrypted response;
relaying, by said approved secure connection module to said out-of-band secure shell module, said encrypted response;
relaying by said out-of-band secure shell module to said authentication server, said encrypted response;
fetching, by said authentication server from said terminal manager database, said private encryption key of said out-of-band secure shell module;
using, by said authentication server, said private encryption key to encrypt said substantially random challenge to produce a replica of the encrypted response;
comparing, by said authentication server, said replica of the encrypted response to said encrypted response, and
if a match is established, sending by said authentication server to said out-of-band secure shell module, a connection authorization message, thereby establishing said maintained direct connection between said out-of-band secure shell module and said approved secure connection module.

2. The terminal management system of claim 1, wherein said terminal manager database, running on said terminal management server is programmed to securely perform discovery of secure shell enabled network devices functionally connected to said enterprise network, and to securely store information regarding said discovered network devices on said terminal manager database including private encryption keys for said discovered network devices.

3. The terminal management system of claim 1, wherein said software module running on said terminal management server further records a log of keystrokes of a workstation on which said secure shell client is running, and stores said log of keystrokes in an encrypted form on said terminal manager database.

4. The terminal management system of claim 1, wherein said substantially random challenge is an alpha-numeric string of 10 characters or greater.

5. A method for managing an enterprise network, comprising:
providing a terminal management server functionally connected to said enterprise network;
providing at least one network device functionally connected to said enterprise network, said network device comprising an out-of-band secure shell module functionally connected to said terminal management server;
providing a secure shell client having a secure connection module; and
establishing a maintained direct connection between said secure shell client and said network device, said establishing comprising:
connecting, by said secure shell client, said secure shell client to said terminal management server;
validating, by an application server operative on said terminal management server, said secure connection module as an approved secure connection module;
receiving by said secure connection module from said application server module, a permission to connect to at least one network device;
establishing, by said approved secure connection module, a preliminary direct connection between said approved secure connection module and said out-of-band secure shell module;
reporting, by said out-of-band secure shell module to an authentication server operative on said terminal management server, said establishment of said preliminary direct connection;
confirming, by said application server, via a challenge response communication with said secure connection module that said secure connection module connected to said out-of-band secure shell module is said validated, approved secure connection module;
issuing by said application server to said approved secure connection module, permission to convert said preliminary direct connection to a temporary direct connection;
creating, by said authentication server, a substantially random challenge;
sending, by said authentication server to said out-of-band secure shell module, said substantially random challenge;
relaying, by said out-of-band secure shell module to said approved secure connection module, said substantially random challenge;
relaying, by said approved secure connection module to said application server, said substantially random challenge;
fetching, from said terminal manager database by said application server, a private encryption key of said network device;
using, by said application server, said private encryption keys to encrypt said substantially random challenge to produce an encrypted response;
sending, by said application server to said approved secure connection module, said encrypted response;
relaying, by said approved secure connection module to said out-of-band secure shell module, said encrypted response;
relaying by said out-of-band secure shell module to said authentication server, said encrypted response;
fetching, by said authentication server from said terminal manager database, said private encryption key of said out-of-band secure shell module;
using, by said authentication server, said private encryption key to encrypt said substantially random challenge to produce a replica of the encrypted response;
comparing, by said authentication server, said replica of the encrypted response to said encrypted response, and
if a match is established, sending by said authentication server to said out-of-band secure shell module, a connection authorization message, thereby establishing said maintained direct connection between said out-of-band secure shell module and said approved secure connection module.
